(19) United States
(12) Patent Application Publication
(10) Pub. No.: US 2014/0157843 A1
(43) Pub. Date: Jun. 12, 2014

(54) DOOR LOCK ASSEMBLY WITH RE-KEYABLE ROTOR

(71) Applicant: Hampton Products International Corporation, Foothill Ranch, CA (US)

(72) Inventors: Jon F. Quan, Fountain Vally, CA (US); Hossein Molaie Shargh, Corona, CA (US)

(73) Assignee: Hampton Products International Corporation, Foothill Ranch, CA (US)

(21) Appl. No.: 14/102,195

(22) Filed: Dec. 10, 2013

Related U.S. Application Data
(60) Provisional application No. 61/736,431, filed on Dec. 12, 2012.

(51) Int. Cl. E05B 27/00

(52) U.S. Cl. CPC E05B 27/005
USPC 70/490; 29/401.1

(57) ABSTRACT

A re-keyable door lock assembly includes a re-keyable rotor having first and second ends, the first end configured to receive a key, the second end terminating in an endpiece. A tailpiece having an actuation end is configured for axial movement between a first axial position in which the actuation end engages the endpiece and a second axial position in which the actuation end is disengaged from the endpiece, wherein the tailpiece is rotatable by the rotor from an unlocked position to a locking position when the rotor is rotated by a key from a first rotational position to a second rotational position when the actuation end of the tailpiece is engaged with the endpiece, and wherein the rotor is rotatable past the second rotational position to a third rotational position only when the actuation end of the tailpiece is disengaged from the endpiece.

### CROSS-REFERENCE TO RELATED APPLICATION

This application claims the benefit, under 35 U.S.C §119(e), of US.. Provisional Application No. 61/736431, filed Dec. 12, 2012, the disclosure of which is incorporated herein by reference in its entirety.

### FEDERALLY SPONSORED RESEARCH OR DEVELOPMENT

Not Applicable.

### BACKGROUND

The present disclosure relates to the field of locksets for doors. More specifically, it relates to keyed cylinder locksets having re-keyable or reprogrammable rotors.

Door lock mechanisms typically include a rotor mounted for rotation within a cylinder by means of a key that is shaped or “bitted” to match the coded tumblers within the rotor. One type of door lock mechanism includes a “re-keyable” rotor, wherein the rotor includes a mechanism that allows a user to reset the key coding tumblers within the rotor for “bitting” a new key without disassembling the rotor or removing the cylinder from the lock unit. This type of rotor is frequently called a “self-rekeying” rotor.

For some self-rekeying rotor technologies, the rotor must be rotated by the original key into a “programming” position (typically 180 degrees from the “home” position) in order for its tumblers to be encoded with the key bitting of the new key. However, in the normal operation, that is, rotating the rotor to lock or unlock the lockset, the rotor typically rotates through or past the programming position.

In the current state of the art, in order to prevent the rotor from being inadvertently reprogrammed, two types of keys are utilized. For normal operations, a key with a notch at the bottom of the blade is used. A protrusion in the cylinder is engaged in this notch to prevent the key from being removed as the rotor passes through the programming position. To reprogram the rotor, a programming key, characterized by material removed from the bottom of the key blade, is used. This “shaved” programming key is designed to pass over the protrusion in the cylinder as the rotor is rotated, and therefore it can be removed from the rotor when the rotor is in the programming position. A second “programming key” (shaved key) with the desired key cuts is then inserted into the rotor (while in the programming position) to encode the rotor with the new key bitting.

One of the challenges with the current technology is the cost and inconvenience of obtaining the second programming key. An alternative to the two key system is to remove the protrusion in the cylinder so that any bitted key common to the keyway in the rotor can be used to program it. However, with this alternative there is a possibility that the rotor could be inadvertently programmed during normal operation. Even with a two programming key system, the rotor passes through the programming position, making it possible for the rotor to be accidentally programmed should the user inadvertently pull the key slightly out of the rotor, thereby defeating the programming key requirement, and encoding the rotor with the wrong key bitting.

### SUMMARY

This disclosure relates to a re-keyable rotor for a door lock assembly. The rotor, which contains tumblers for encoding the key bitting, includes a mechanism that is operable to restrict the rotor from being rotated to the programming position during normal operation. When it is desired to re-program the rotor, the user activates a rotation release mechanism, enabling the rotor to be rotated to the programming position.

Broadly, the present disclosure relates to a re-keyable door lock assembly, comprising a rotor having a first end configured for receiving a key and a second end opposite the first end; an endpiece on the second end of the rotor; and a tailpiece having an actuation end, the tailpiece being configured for axial movement between a first axial position in which the actuation end engages the endpiece and a second axial position in which the actuation end is disengaged from the endpiece, wherein the tailpiece is rotatable by the rotor from an unlocked position to a unlocking position when the rotor is rotated by a first key having a first bitting pattern from a first rotational position to a second rotational position when the actuation end of the tailpiece is engaged with the endpiece, and wherein the rotor alone is rotatable past the second rotational position to a third rotational position (which is the programming position) only when the actuation end of the tailpiece is disengaged from the endpiece. When the rotor is in the third rotational (programming) position, the first key may be removed from the rotor and replaced by a second key having a second (different) bitting pattern, wherein the rotor is rotatable by the second key back to the second rotational position, at which point the actuation end of the tailpiece is re-engageable with the endpiece of the rotor.

The benefit of this arrangement is twofold. First, it eliminates the need for a separate programming key, saving the cost and the inconvenience of making the programming key. Second, the rotor is prevented from rotating to or through the programming position during normal operation (i.e., when the actuation end of the tailpiece is engaged with the endpiece of the rotor), thus greatly reducing the chance of the user accidentally reprogramming the rotor.

### BRIEF DESCRIPTION OF THE DRAWINGS

Exemplary embodiments are explained in more detail below with reference to the drawings, in which:

FIG. 1 is a simplified, exploded, perspective view of a re-keyable rotor for keyed cylinder lock assembly in accordance with a first embodiment of the present disclosure;

FIGS. 2A and 2B show a tailpiece actuation end and a rotor endpiece in accordance with the embodiment of FIG. 1;

FIGS. 3A-3C show a tailpiece actuation end and a rotor endpiece in accordance with a second embodiment of the present disclosure;

FIGS. 4A-4C show a tailpiece actuation end and a rotor endpiece in accordance with a third embodiment of the present disclosure; and

FIGS. 5A-5H are simplified views of a door lockset incorporating a keyed lock assembly according to the present disclosure, showing how the lock assembly is operated to re-key the rotor.

### DETAILED DESCRIPTION

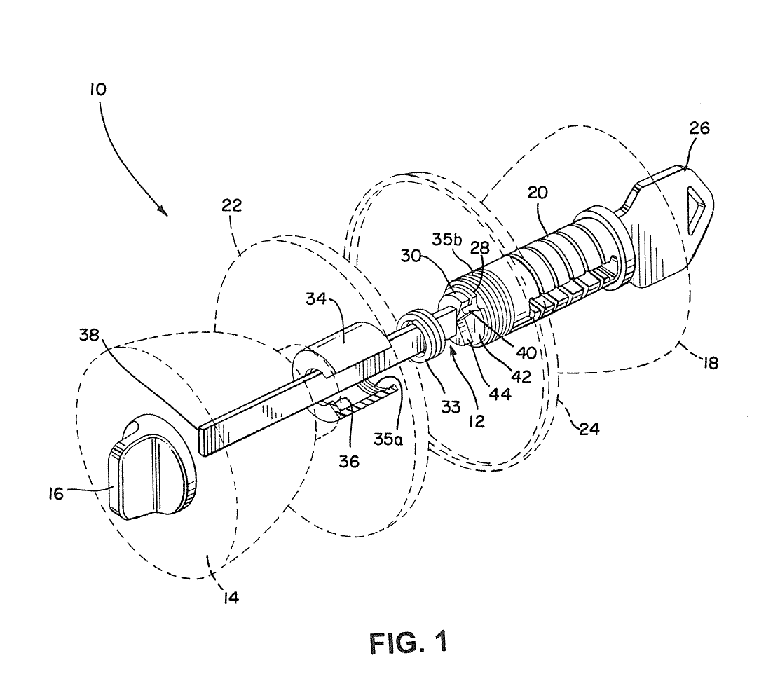

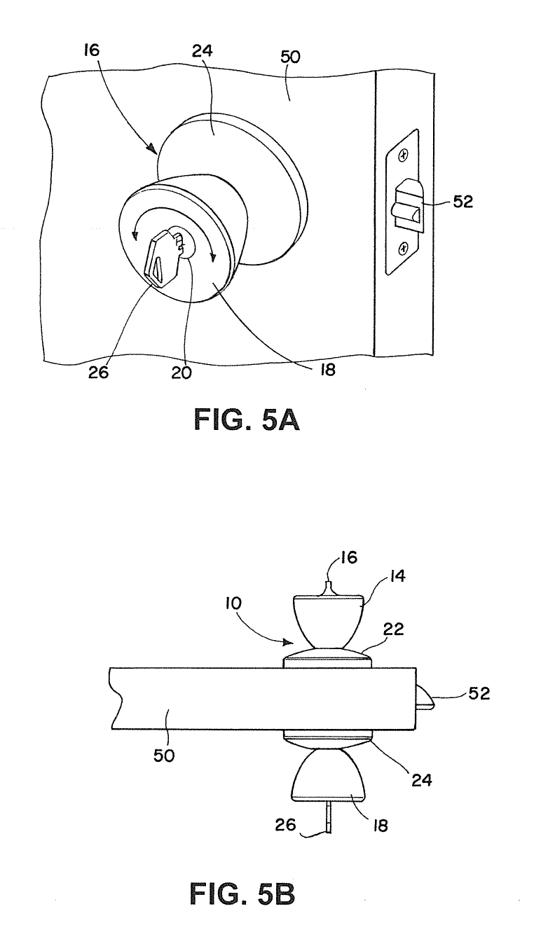

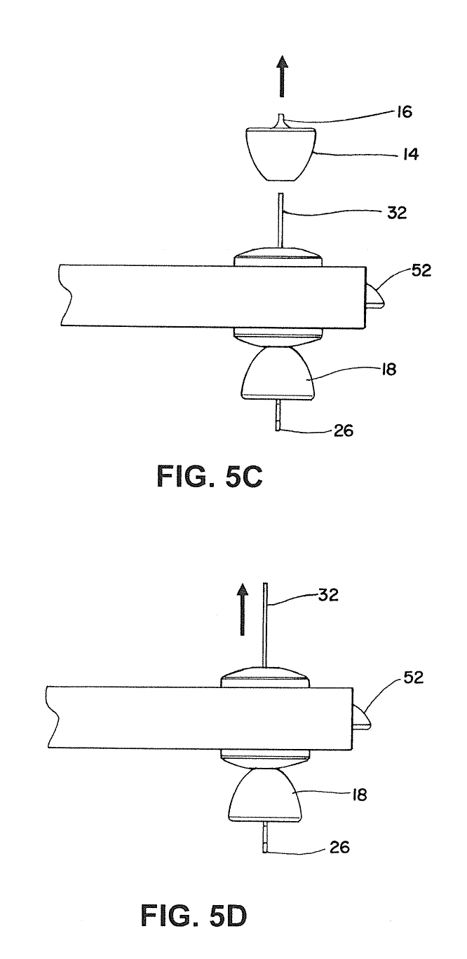

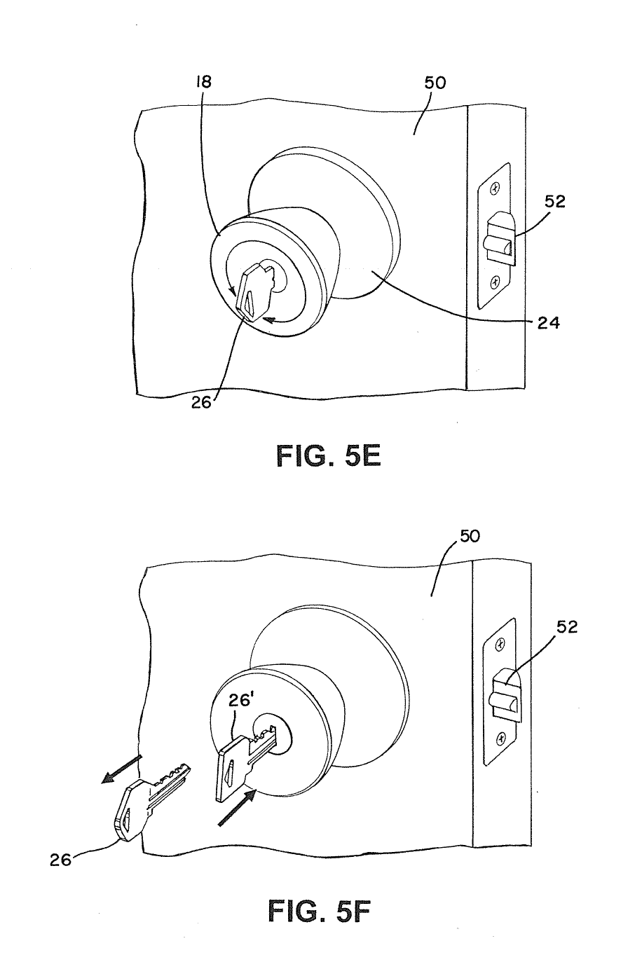

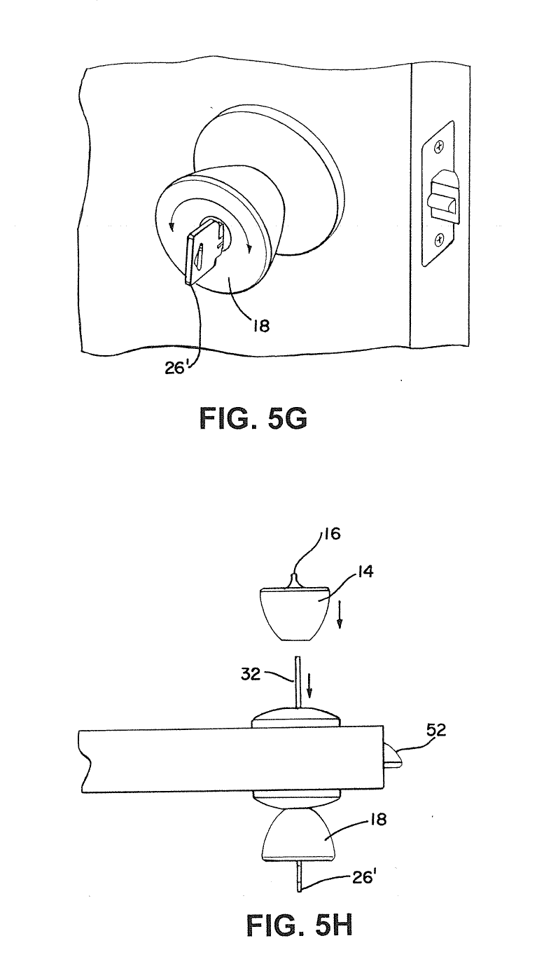

FIG. 1 shows a simplified view of door lockset 10 including a re-keyable lock assembly 12 in accordance with the present disclosure. (The latch mechanism that is typically part of the lockset has been removed for clarity.) The lockset 10 is installed in a door (see FIGS. 5A-5H), with the lock assembly 12 installed through an aperture in the door. The lockset 10 includes an inside doorknob 14 having a manually-actuated central turnpiece 16, and an outside doorknob 18 that encloses a re-keyable rotor 20 that contains a plurality of coded tumblers (not shown), as is well known and conventional. The lockset 10 is fixed to the inside surface of the door by an inside mounting plate or rose 22, and to the outside surface of the door by an outside mounting plate or rose 24. The rotor 20 is typically disposed centrally and coaxially in the outside doorknob 18.

The rotor 20 includes a slotted opening (not shown), which is the entrance to a keyway for the insertion of a key 26 having a blade (not shown) that is cut or “bitted” to actuate the coded tumblers. An endpiece 28, fixed to the back or inner end of the rotor 20, is configured for disengageable co-engagement with a first or actuation end 30 of a tailpiece 32, as will be described below. The tailpiece 32 is biased axially outward (in the context of the lockset 10) into engagement with the endpiece 28 by a biasing mechanism. In a specific embodiment, the biasing mechanism may advantageously comprise, for example, a biasing element, such as a coil spring 33 disposed coaxially around the tailpiece 32 near the actuation end 30 thereof. The coil spring 33 has a first or outer end that is seated against the actuation end 30 of the tailpiece 32. The biasing element (e.g., the spring 33) is contained within a cylindrical housing 34 coaxially disposed on the tailpiece 32 and having an outer end with internal threads 35a that detachably couple with external threads 35b on the rotor 20 adjacent the endpiece 28. The inner end of the housing 34 defines an annular spring seat 36, against which the second or inner end of the spring 33 is seated. Thus, the spring 33, captured between spring seat 36 of the housing 34 (which, in turn, is fixed to the rotor 20) and the actuation end 30 of the tailpiece 32, urges the tailpiece 32 into operative engagement with the rotor endpiece 28.

The tailpiece 32 is otherwise conventionally configured for operative engagement with a door latch mechanism (see FIGS. 5A-5H), as is well-known in the art. As is also conventional, the tailpiece 32 has a second or outer end 38 that is engaged by the manually-actuated turnpiece 16 in the inside doorknob 14.

In typical operation, the tailpiece 32 is rotatable either by the rotor 20 or the turnpiece 16 between a first (unlocked) rotational position and a second (locked) rotational position. In the first rotational position, the tailpiece 32 is in an unlocked engagement with the latching mechanism (not shown). In this position, the rotor 20, and thus the outside doorknob 18 to which it is fixed, may be turned to actuate the latch mechanism to open the door. The door is thus unlocked. The door can now be locked either (a) by manually rotating the turnpiece 16 to rotate the tailpiece 32 to its second rotational position, in which the tailpiece 32 is in a locked engagement with the latch mechanism, or (b) by using the key 26 to rotate the rotor 20 and the endpiece 28, thus rotating the tailpiece 32 to its second rotational position. With the tailpiece 32 in its second rotational position, the doorknobs 14, 18 are unable to be turned to actuate the latch mechanism, thereby locking the door.

The co-engagement of the endpiece 28 and the actuation end 30 of the tailpiece 32 is such that the tailpiece 32, once disengaged from the endpiece 28 (as will be described below), will only re-engage with the endpiece 28 when the rotor 20 is rotated to a predetermined rotational position. For example, the endpiece 28 and the actuation end 30 of the tailpiece 32 may be configured so that their re-engagement is possible only when the rotor 20 has been returned (counter-rotated) back at least to the second rotational position, or somewhere between the first and second rotational positions.

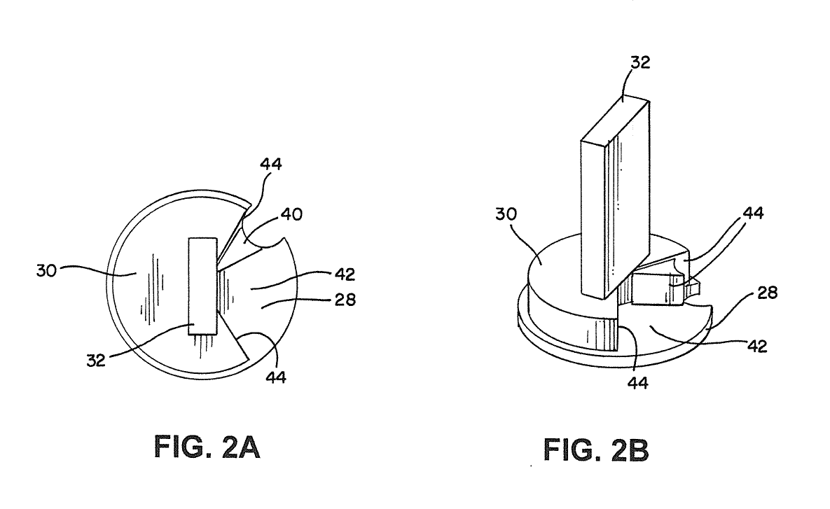

The interface between the endpiece 28 and the tailpiece 32 is configured to limit the rotation of the rotor 20. Thus, in the embodiment shown in FIGS. 1, 2A, and 2B, the endpiece 28 of the rotor 20 is configured as a substantially circular disc with a wedge-shaped stop element 40 extending from its inner or rear surface. The actuation end 30 of the tailpiece 32 is configured as a disc with a wedge-shaped cut-out section or gap 42 subtending an arc of between about 45 degrees and 180 degrees, preferably between 90 degrees and 150 degrees, and most advantageously about 120 degrees, as shown. The cut-out section or gap 42 is bounded by a pair of radial walls 44 that are engageable with the raised stop element 40 on the rotor endpiece 28.

Under the force applied by the biasing element 33, the tailpiece 32 is axially biased to bring its actuation end 30 into engagement with the endpiece 28. With the tailpiece 32 and the endpiece 28 thus engaged, the rotation of the rotor 20 is limited by the stop element 40. In the illustrated example, in which the stop element 40 subtends about 30 degrees of arc, the rotation of the rotor 20 is limited to about 90 degrees in either direction. The limits of this rotational movement are, of course, a function of the configurations of the actuation end 30 and the stop element 40, and may be more or less than 90 degrees.

FIG. 2A and FIG. 2B show a detail of the rotor endpiece 28 in engagement with the tailpiece actuation end 30 shown in FIG. 1. The actuation end 30 of the tailpiece 32 comprises a circular disc having a wedge-shaped cut-out section or gap 42 subtending between about 90 degrees and about 180 degrees (preferably 120 degrees) of arc, thereby providing a pair of radial walls 44 that are engageable with a raised, wedge-shaped stop element 40 on the endpiece 28. In this configuration, when the actuation end 30 of the tailpiece 32 is engaged with the rotor endpiece 28, the rotor 20 (to which the endpiece 28 is fixed) may be rotated either clockwise or counterclockwise until one of the radial walls 44 abuts against the stop element 40 on the rotor endpiece 28. The amount of rotation is defined by the angle of arc defined between the walls 44 and the angle of arc subtended by the stop element 40.

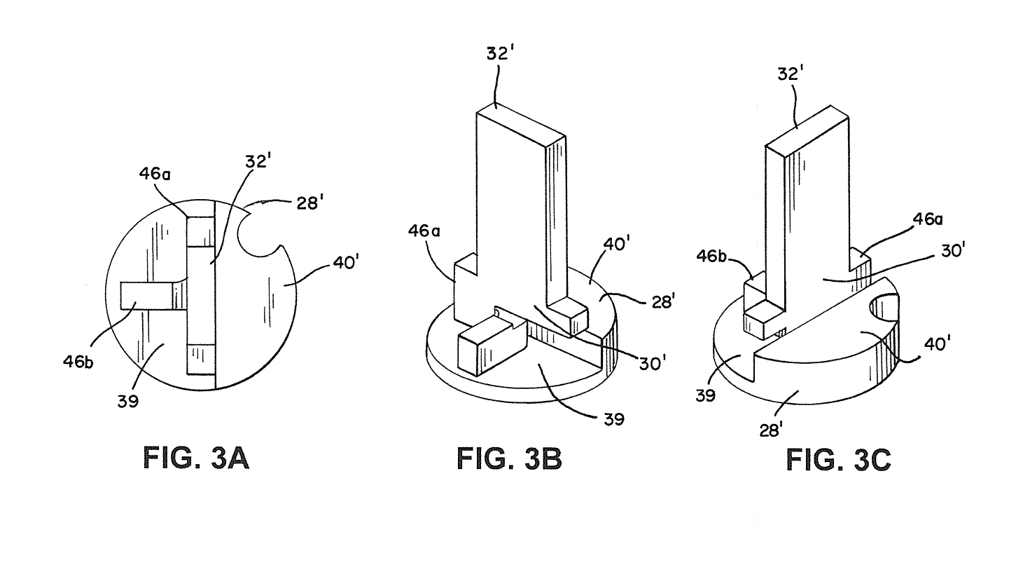

Another embodiment is shown in FIGS. 3A, 3B, and 3C, wherein a rotor endpiece 28′ is configured as a disc with a substantially circular flat portion 39 and a substantially semicircular raised portion that functions as a stop element 40′. A tailpiece 32′ terminates in an actuation end 30′ with two fingers 46a, 46b resting on the flat portion 39 and oriented at a 90 degree angle with respect to each other, whereby, when the actuation end 30′ of the tailpiece 32′ is engaged with the endpiece 28′, one of the fingers 46a, 46b abuts against the stop element 40′ when the endpiece 28′ is in a first rotational position, and the other of the fingers 46a, 46b abuts against the stop element 40′ when the endpiece 28′ is rotated to a second rotational position approximately 90 degrees from the first position. With this configuration, the rotor rotation is limited to about 90 degrees when the tailpiece 32′ and the endpiece 28′ are engaged.

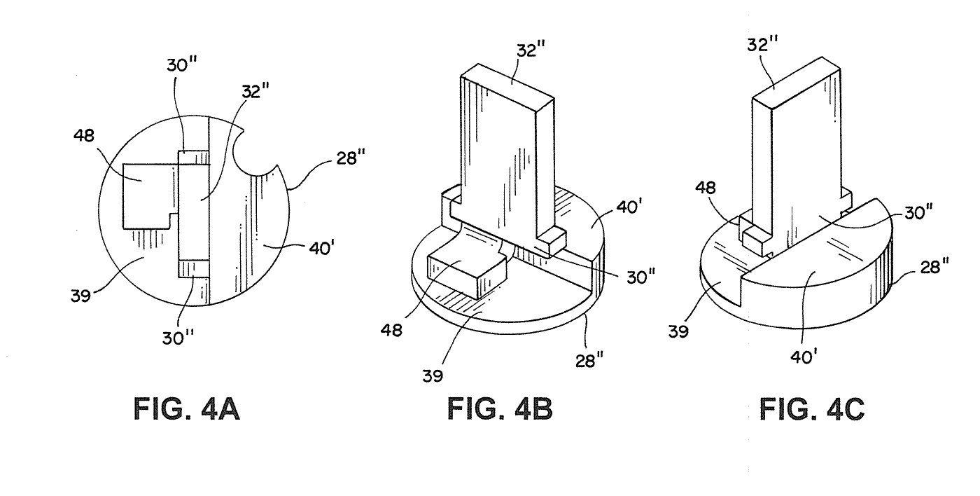

Still another embodiment is shown in FIGS. 4A, 4B, and 4C, which includes an endpiece 28″ configured as a disc with a substantially semicircular flat portion 39 and a substantially semicircular raised portion that functions as a stop element 40′, as in the above-described embodiment of FIGS. 3A-3C. This embodiment includes a tailpiece 32″ having an actuation end 30″ terminating in a single finger 48 configured to rest on the flat portion 39 of the endpiece 28″ when the actuation end 30″ of the tailpiece 32″ is engaged with the endpiece 28″, whereby the finger 48 abuts against the stop element 40′ when tailpiece 32″ is rotated a predetermined amount (e.g., approximately 90 degrees) from a first or neutral rotational position (shown in the drawings) to a second rotational position relative to the endpiece 28″.

All of the above embodiments of the interface between the rotor endpiece and the tailpiece permit the tailpiece, having been disengaged from the rotor endpiece as described below, to re-engage with the rotor, and specifically the rotor endpiece, only when the rotor is in a predefined rotational position, as described above. By using an endpiece with an asymmetric configuration, the tailpiece is unable to re-engage with the endpiece until the latter is in the predefined rotational orientation relative to the rotor endpiece. (The term “engage,” as applied to the relationship between the rotor endpiece and the actuation end of the tailpiece, is understood to mean an axial relationship between these elements in which the rotation of the tailpiece is limited by the stop element of the endpiece.)

A method by which the tailpiece may be disengaged from the rotor and, specifically, from the rotor endpiece, may be understood with reference to FIGS. 1 and 5A-5H. Because all of the above-described embodiments and their equivalents will be identical in operation, the description below will reference the embodiment of FIGS. 1 and 2A-2C, but it will apply equally to the other embodiments and any equivalents.

In a typical keyed cylinder lock construction, the tailpiece 32 is either assembled integrally with the inner end of the rotor 20 or with a rotor endpiece 28 that is fixed to the rotor 20, or it is positioned in the lock so as to be constantly engaged with the inner or back end of the rotor 20. In accordance with this disclosure, however, as shown in FIG. 1, the tailpiece 32 and the rotor endpiece 28 are separate components. The tailpiece 32, as mentioned above, is positively biased in an endpiece-engaging position by the biasing mechanism, such as the coil spring 33 contained in the spring housing 34 that is fixed to the rotor 20, and that defines the annular spring seat 36, as described above. When the tailpiece 32 is engaged with the endpiece 28, the tailpiece 32 is rotatable by the rotor when the rotor is rotated by a key from the first rotational position to the second rotational position, and vice versa, thereby locking and unlocking the latching mechanism. The tailpiece, however, is constrained from being rotated past the second rotational position by the latching mechanism. Thus, when the tailpiece is engaged with the endpiece of the rotor, the rotor cannot be rotated past the second rotational position to the third rotational position, and thus cannot be re-programmed with a new key.

When a force is applied to the tailpiece 32 in an axial direction away from the rotor 20 (i.e., against the bias of the biasing mechanism), the tailpiece 32 is moved axially away from the rotor 20, compressing the biasing element or spring 33 in the housing 34. This movement disengages the actuation end 30 of the tailpiece 32 from the rotor endpiece 28, allowing the rotor 20 to be rotated from a first or unlocked rotational position, past a second or locking rotational position, to a third or programming rotational position, at which the rotor 20 may be re-programmed (re-keyed) as described below. The rotor 20 is then returned (counter-rotated) back to a pre-defined rotational position (preferably the second rotational position), at which point the tailpiece 32 is released, whereupon the axial biasing force applied by the biasing element 33 returns the tailpiece to a position in which the actuation end 30 re-engages with the endpiece 28. The actuation end 30 and the endpiece 28 cannot re-engage until the rotor 20 is returned to the pre-defined re-engagement position after re-programming.

FIGS. 5A-5H illustrate one exemplary method of reprogramming a keyed lock rotor in accordance with the present disclosure. These figures show a lockset in accordance with the present disclosure installed in a door 50. The lockset includes an inside doorknob 14 and an outside doorknob 18 connected by a latch actuation mechanism (not shown) installed within the door 50 for actuation of a door latch 52 in a conventional manner. The lockset is fixed to the door 50 by an inside rose 22 and an outside rose 24, as described above.

FIGS. 5A and 5B show the installed lockset 10 in an unlocked condition. The turnpiece 16 in the inside doorknob 14 is in its unlocked position. A first key 26, having a first bitting pattern, is inserted into the rotor 20 in the outside doorknob 18, but it has not been used to rotate the rotor. The doorknobs 14, 18 are therefore free to be rotated to actuate the latch mechanism so as to withdraw the latch 52, allowing the door to be opened.

FIGS. 5C and 5D show the lockset being prepared for re-programming in accordance with one exemplary embodiment of the disclosure. In this embodiment, the inside doorknob 14 and the turnpiece 16 are removably attached, as a unit, to the tailpiece 32, for example, by means of set screws or the like (not shown). Alternatively, the turnpiece 16 alone may be removably attached to the second or inner end of the tailpiece 32, leaving the inside doorknob 14 connected to the tailpiece 32. In either case, the second or inner end of the tailpiece 32 is left exposed after the inside doorknob/turnpiece unit (or, alternatively, just the turnpiece 16) is removed, as shown in FIG. 5C. Then, as shown in FIG. 5D, the tailpiece 32 is pulled axially, against the force of the above-described biasing mechanism, away from the door, thereby disengaging the actuation end 30 of the tailpiece 32 from the endpiece 28 of the rotor 20, as described above.

As shown in FIG. 5E, with the tailpiece 32 disengaged from the rotor 20, the rotor is free to be rotated past its locking position (second rotational position) to its programming position (third rotational position) by means of the key 26. Once in the programming position, the rotor 20 may be reprogrammed with a new key 26′, as shown in FIG. 5F. The new or second key 26′ has a second bitting pattern different from the bitting pattern of the first key 26.

With the new key 26′, the rotor 20 may be rotated, as shown in FIG. 5G, out of the programming position to another rotational position (e.g., the locking position), in which the rotor endpiece 28 is positioned for re-engagement with the actuation end 30 of the tailpiece 32, as described above. The tailpiece 32 is then released, allowing the biasing mechanism to move it axially toward the rotor 20 (see FIG. 5H), until the actuation end 30 of the tailpiece 32 once again engages the endpiece 28 of the rotor 20, as described above. The inside doorknob/turnpiece unit (or, alternatively the turnpiece 16) is then re-attached to the inside end of the tailpiece 32, as shown in FIG. 5H.

The embodiments described in this disclosure are exemplary only. Variations and modifications of these embodiments may suggest themselves to those skilled in the pertinent arts, as may other embodiments equivalent to those explicitly disclosed herein. Such variations, modifications, and other embodiments are understood to be encompassed within the scope of this disclosure.

What is claimed is:

1. A re-keyable door lock assembly, comprising;
a re-keyable rotor having a first end configured for receiving a key and a second end opposite the first end;
an endpiece on the second end of the rotor; and
a tailpiece having an actuation end, the tailpiece being configured for axial movement between a first axial position in which the actuation end engages the endpiece and a second axial position in which the actuation end is disengaged from the endpiece, wherein the tailpiece is rotatable by the rotor from an unlocked position to a locking position when the rotor is rotated by a key from a first rotational position to a second rotational position when the actuation end of the tailpiece is engaged with the endpiece, and wherein the rotor is rotatable past the second rotational position to a third rotational position only when the actuation end of the tailpiece is disengaged from the endpiece.

2. The re-keyable door lock assembly of claim 1, wherein the key is a first key having a first bitting pattern, wherein the rotor is rotatable by a second key from the third rotational position back to the second rotational position, and wherein the second key has a second bitting pattern different from the first bitting pattern.

3. The re-keyable door lock assembly of claim 1, wherein, after the rotor has been rotated to the third rotational position, the endpiece is configured to be re-engageable with the actuation end of the tailpiece only when the rotor is returned at least to the second rotational position.

4. The re-keyable door lock assembly of claim 1, further comprising a biasing mechanism configured to bias the tailpiece axially toward the first axial position.

5. The re-keyable door lock assembly of claim 1, wherein the endpiece includes a stop element configured to limit the rotation of the rotor between the first and second rotational positions when the actuation end of the tailpiece is engaged with the endpiece.

6. The re-keyable door lock assembly of claim 5, wherein the stop element defines first and second wall surfaces, and wherein the actuation end of the tailpiece is configured to abut against the first wall surface when the actuation end of the tailpiece is engaged with the endpiece and the rotor is in the first rotational position, and to abut against the second wall surface when the actuation end of the tailpiece is engaged with the endpiece and the rotor is in the second rotational position.

7. The re-keyable door lock assembly of claim 4, wherein the biasing mechanism comprises:
a hollow cylindrical housing coaxially disposed around the tailpiece and having a distal end defining an annular spring seat and a proximal end configured for attachment to the second end of the rotor; and
a biasing element in the housing and seated between the spring seat and the actuation end of the tailpiece, the biasing element being configured for biasing the actuation end of the tailpiece into engagement with the endpiece.

8. The re-keyable door lock assembly of claim 7, wherein the biasing element includes a coil spring disposed coaxially around the tailpiece adjacent the actuation end thereof.

9. The re-keyable door lock assembly of claim 1, wherein the tailpiece extends axially from the actuation end through a doorknob and terminates in an inner end opposite the actuation end, and wherein the re-keyable door lock assembly further comprises a turnpiece removably connected to the inner end of the tailpiece and configured to rotate the tailpiece between a locking rotational position and an unlocking rotational position.

10. A re-keyable door lock assembly, comprising:
a re-keyable rotor having a first end configured for receiving a key and a second end opposite the first end, the rotor being operable by the key for rotation between first, second, and third rotational positions;
an endpiece on the second end of the rotor; and
a tailpiece configured for axial movement between a first axial position in which the tailpiece is engaged with the endpiece and a second axial position in which the tailpiece is disengaged from the endpiece, wherein the tailpiece is rotatable by the rotor from an unlocked position to a locking position when the rotor is rotated by the key from the first rotational position to the second rotational position when the tailpiece is engaged with the endpiece, wherein the rotor is prevented from rotation from the second rotational position to the third rotational position by the engagement of the tailpiece with the endpiece, and wherein the rotor alone is rotatable past the second rotational position to the third rotational position only when the tailpiece is disengaged from the endpiece.

11. The re-keyable door lock assembly of claim 10, wherein the endpiece includes a stop element, and wherein the tailpiece has an actuation end that is in a rotation-limiting engagement with the stop element when the tailpiece is in the first axial position.

12. The re-keyable door lock assembly of claim 10, further comprising a biasing mechanism configured for biasing the tailpiece toward the first axial position.

13. The re-keyable door lock assembly of claim 10, wherein the key is a first key having a first bitting pattern, wherein the rotor is rotatable by a second key from the third rotational position back to the second rotational position, and wherein the second key has a second bitting pattern different from the first bitting pattern.

14. The re-keyable door lock assembly of claim 10, wherein, after the rotor has been rotated to the third rotational position, the endpiece is configured to be re-engageable with the actuation end of the tailpiece only when the rotor is returned at least to the second rotational position.

15. The re-keyable door lock assembly of claim 11, wherein the stop element is configured to limit the rotation of the rotor between the first and second rotational positions when the actuation end of the tailpiece is engaged with the endpiece.

16. The re-keyable door lock assembly of claim 15, wherein the stop element defines first and second wall surfaces, and wherein the actuation end of the tailpiece is configured to abut against the first wall surface when the actuation end of the tailpiece is engaged with the endpiece and the rotor is in the first rotational position, and to abut against the second wall surface when the actuation end of the tailpiece is engaged with the endpiece and the rotor is in the second rotational position.

17. The re-keyable door lock assembly of claim 12, wherein the biasing mechanism comprises:
a hollow cylindrical housing coaxially disposed around the tailpiece and having a distal end defining an annular spring seat and a proximal end configured for attachment to the second end of the rotor; and
a biasing element in the housing and seated between the spring seat and the actuation end of the tailpiece, the biasing element being configured for biasing the actuation end of the tailpiece into engagement with the endpiece.

18. The re-keyable door lock assembly of claim 17, wherein the biasing element includes a coil spring disposed coaxially around the tailpiece adjacent the actuation end thereof.

19. The re-keyable door lock assembly of claim 1, wherein the tailpiece extends axially from the actuation end through a doorknob and terminates in an inner end opposite the actuation end, and wherein the re-keyable door lock assembly further comprises a turnpiece removably connected to the inner end of the tailpiece and configured to rotate the tailpiece between a locking rotational position and an unlocking rotational position.

20. In a keyed cylinder door lock assembly, of the type having a re-keyable rotor operable by a key and having an inner end configured as an endpiece engageable by tailpiece that actuates a door latch in response to the rotation of the rotor, the method comprising:
(a) with the endpiece engaged by the tailpiece, rotating the rotor and the tailpiece with a first key having a first bitting pattern from a first rotational position to a second rotational position;
(b) disengaging the tailpiece from the endpiece of the rotor;
(c) rotating the rotor alone with the first key past the second rotational position to a third rotational position;
(d) removing the first key;
(e) rotating the rotor alone back to the second rotational position using a second key having a second bitting pattern different from the first bitting pattern; and
(f) re-engaging the tailpiece with the endpiece of the rotor.

21. The method of claim 20, wherein the disengagement of the tailpiece from the endpiece is performed by pulling the tailpiece axially away from the endpiece.

22. The method of claim 21, wherein the tailpiece is biased axially toward the endpiece, whereby the disengagement of the tailpiece from the endpiece is performed by pulling the tailpiece axially against the bias, and whereby the re-engagement of the tailpiece with the endpiece is performed by releasing the tailpiece.

23. The method of claim 20, wherein the engaging of the tailpiece with the endpiece prevents the rotation of the rotor from the second rotational position to the third rotational position.
